(19) United States
(12) Patent Application Publication
(10) Pub. No.: US 2023/0289634 A1
(43) Pub. Date: Sep. 14, 2023

(54) NON-LINEAR CAUSAL MODELING BASED ON ENCODED KNOWLEDGE

(71) Applicant: Alibaba Group Holding Limited, CAYMAN ISLANDS (KY)

(72) Inventors: Yan Li, Bellevue (US); Chunchen Liu, Beijing (CN); Yiqiao Sun, Hangzhou (CN)

(21) Appl. No.: 18/199,024

(22) Filed: May 18, 2023

Related U.S. Application Data
(63) Continuation of application No. PCT/CN2020/129910, filed on Nov. 18, 2020.

(51) Int. Cl. G06N 7/01; G06F 17/16

(52) U.S. Cl. CPC G06N 7/01; G06F 17/16

(57) ABSTRACT

The present disclosure provides optimizing a causal additive model conforming to structural constraints of directedness and acyclicity, and also encoding both positive and negative relationship constraints reflected by prior knowledge, so that the model, during fitting to one or more sets of observed variables, will tend to match expected observations as well as domain-specific reasoning regarding causality, and will conform to directedness and acyclicity requirements for Bayesian statistical distributions. Computational workload is decreased and computational efficiency is increased due to the implementation of causal additive model improvements to reduce search space and enforce directedness, while intuitive correctness of the outcome causality is ensured by prioritizing encoding of prior knowledge over optimizing a loss function.

### CROSS REFERENCE TO RELATED APPLICATIONS

This application claims priority to and is a continuation of PCT Patent Application No. PCT/CN2020/129910, filed on 18 Nov. 2020 and entitled “NON-LINEAR CAUSAL MODELING BASED ON ENCODED KNOWLEDGE,” which is incorporated herein by reference in its entirety.

### BACKGROUND

Causal inference is a broad field of study to determine whether one event causes another, which may further result in actionable predictions of future events. For example, values of goods, property, and assets on the market may change over time due to phenomena such as changes of seasons, changes of weather, changes of public policy, and the like. By determining that changes of some variables cause changes of other variables, actionable predictions may be made to, for example, set prices efficiently based on anticipated market price changes.

Such phenomena which serve as a basis for causal inference may be represented as a set of variables. For example, as mentioned above, market price, seasons, weather, policy, and the like may each be represented by a variable. The performance of causal inference involves drawing causal relationships between different variables of such a set. Causal relationships maybe encoded in various logical constructs, such as a causal graph, wherein nodes represent variables and edges represent relationships therebetween.

Causal inference may be performed over sets of variables by fitting a regression model to observed values of the variables. The regression model may be implemented according to linear causality, assuming that causal relationships are unidirectional, where each such unidirectional relationship may be represented by a linear equation.

However, non-linear causality models also exist to model more complex causal relationships. Established regression computation methods for non-linear causality models suffer from several limitations, including the need to calculate computationally intensive high-dimension operations; failure to fully generate directionality in causal graphs; lack of computational efficiency; and the like. Thus, there is a need for improved regression of causal inference by non-linear causality models.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a causal additive model method according to example embodiments of the present disclosure.

FIGS. 2A and 2B illustrate a system architecture of a system configured to compute causal additive modeling regression according to example embodiments of the present disclosure.

FIG. 3 illustrates an architectural diagram of server host(s) and a remote computing host for computing resources and a causal additive modeling regression model according to example embodiments of the present disclosure.

FIG. 4 illustrates an example computing system for implementing the processes and methods described above for implementing a causal additive modeling regression model.

### DETAILED DESCRIPTION

Systems and methods discussed herein are directed to implementing a causal additive model, and more specifically implementing non-linear regression based on encoded prior knowledge to construct a causal additive model by a directed acyclic graph topology.

A regression model, according to example embodiments of the present disclosure, may be a set of equations fitted to observations of values of variables. A regression model may be computed based on observed data, and computation of the model may include inference of causal relationships between variables of the observed data. A computed regression model may be utilized to forecast or predict future values of variables which are part of the regression model.

A regression model may be, for example, based on linear causality or non-linear causality. According to linear causality, for a set of variables {x₁, x₂, . . . , xₚ}, a causal relationship between variables xᵢ and xⱼ may be modeled by a linear equation of the format xⱼ=βxᵢ+ϵ, where β is a parameter of the linear equation which may be fitted during regression, and ϵ is a constant which may represent, for example, noise in values of the observed variables. This equation indicates that xⱼ is dependent upon xᵢ and xᵢ is not dependent upon xⱼ.

Causal relationships may logically map to a causal graph topology, wherein a variable is mapped to a vertex. A (directional) edge between two vertices may represent an inferred causal relationship between the variables represented by the two vertices (in the direction of the edge), and the absence of an edge between two vertices may represent an inferred absence of a causal relationship between the variables represented by the two vertices (in either direction). A directional edge may flow from a parent vertex in the direction of a child vertex.

A Bayesian network may be utilized as a structural constraint in causal inference models. For example, a Bayesian network may impose the structural constraint that an inferred causality model should be a directed acyclic graph (“DAG”), wherein no sequence of edges starting from any particular vertex will lead back to the same vertex. Persons skilled in the art will generally appreciate that acyclicity of DAG is a conventionally accepted structural constraint on causal inference models for the purpose of facilitating computations of Bayesian statistical distributions; further details thereof need not be elaborated upon herein for understanding of example embodiments of the present disclosure.

Additionally, according to non-linear causality, more complex causal relationships may emerge. A causal relationship between variables xᵢ and xⱼ may be modeled by an equation of the format xⱼ=ƒ(xᵢ)+ϵ, where ƒ(x) is any function, which may include a non-linear function, and ϵ is a constant which may represent, for example, noise in values of the observed variables. This equation indicates that xⱼ is dependent upon xᵢ, and, furthermore, that xᵢ may also be dependent upon xⱼ.

In fitting a regression model according to non-linear causality, it is desired to estimate a function ƒ(x) fitting observations of the set of variables. Such functions are generally estimated by nonparametric regression, as the functions cannot be estimated by parameterizing a statistical distribution as in linear regression.

A number of approaches to nonparametric regression utilize additive modeling to estimates a function. Additive modeling may be based on one or more kernel smoothers, wherein a kernel function based on a probability distribution is applied as a weighting factor to observed values of variables, smoothing the observed values to facilitate regression to an estimated function.

For example, one such approach is the kernel PC (“kPC”) algorithm, wherein it is assumed that each variable may be regressed on its own dependent variables to determine an independent function ƒ(x) as above. However, this approach leaves the possibility that each ƒ(x) may be non-linear. The regression of a number of non-linear functions is generally computationally intensive due to the performance of high-dimensional computations, thus rendering such a solution computationally inefficient. Additionally, this approach is limited to generating partially directed acyclic graphs, and cannot guarantee generating DAGs.

Another proposed approach is the structural equational likelihood framework (“SELF”), which establishes a causal network, then searches the network to optimize a causal network topology. However, SELF also lacks computational efficiency, as the network search is greedy and thus increases in computational intensity with network size.

According to example embodiments of the present disclosure, a causal additive model is utilized to overcome the above-mentioned limitations of other approaches to causal network generation. A causal additive model (“CAM”), as proposed by Buhlmann et al., performs preliminary neighborhood selection, so as to reduce search space for a network search, increasing computational efficiency by reducing workload.

Moreover, the CAM approach is enhanced to add an additional advantage: the encoding of prior knowledge in a causal network before a network search begins. Prior knowledge may include, for example, various types of apriori knowledge which may be determined by reasoning based on specialized domain knowledge. For instance, given a set of variables where a first variable a represents geographical location and another variable b represents temperature, specialized domain knowledge may reason that geographical locations at certain altitudes experience high temperatures due to tropical climates. Thus, prior knowledge may reveal that b has a dependency upon a; encoding this a priori knowledge into a causal network before a regression modeling process may simplify the network connections which need to be searched, thereby decreasing workload and increasing computational efficiency. The resulting causal network may also be made more accurate by the encoding of prior knowledge.

For the purpose of understanding example embodiments of the present disclosure, four types of prior knowledge may be denoted, as follows:

The notation a [symbol] b signifies that a is known as not having a direct parent causal relationship to b. Thus, a causal network should not contain a directed edge from a to b, though this does not preclude any other relationship between a and b.

The notation a→b signifies that a is known as having a direct parent causal relationship to b. Thus, a causal network should contain a directed edge from a to b.

The notation a↔b signifies that a and b are known as having a direct causal relationship therebetween, with directionality unknown. Thus, a causal network should ultimately contain either a directed edge from a to b, or a directed edge from b to a.

The notation a [symbol] b signifies that a precedes b, and therefore, conversely, b is not an ancestor of a. Thus, a causal network should not contain any path of directed edges where first b is encountered, then a is encountered, along the path.

The notation a [symbol] b signifies that a succeeds b, and therefore, conversely, a is not an ancestor of b. Thus, a causal network should not contain any path of directed edges where first a is encountered, then b is encountered, along the path.

Prior knowledge encoded by preceding and succeeding relationships may encompass multiple pieces of prior knowledge encoded by direct relationships. For example, a [symbol] b or a [symbol] b may invalidate any direct relationship between two variables which are neither a nor b, in the event that such direct relationships create a path from b to a, or from a to b, respectively. To distinguish these two categories of relationships, the present disclosure may subsequently make reference to “direct relationships” and “preceding and succeeding relationships.”

According to the CAM approach, by the application of one or more kernel smoother functions ƒ(·): [symbol] → [symbol] , Ran equation modeling a causal relationship may be generalized as follows:

$${x}_{j} = {\sum }_{k ϵ {pa}_{π} ( j )} {f}_{j , k} ( {x}_{l} ) + {ϵ}_{j} , j = 1 , … , p$$

Herein, ϵ₁, . . . , ϵₚ is a series of constants, such as noise terms, for each variable x₁, x₂, . . . , xₚ, where each ϵₚ is independent of each other ϵⱼ term. Furthermore, the variable π encodes a causal network topology, with pa_{π}(j) being a set of variables within the network topology which are represented by parent vertices to a child vertex representing xⱼ. According to example embodiments of the present disclosure, an objective of regression modeling is to estimate an approximation of ƒ_{j,k}(·), denoted by convention as \hat{ƒ}_{j,k}^{π}(·).

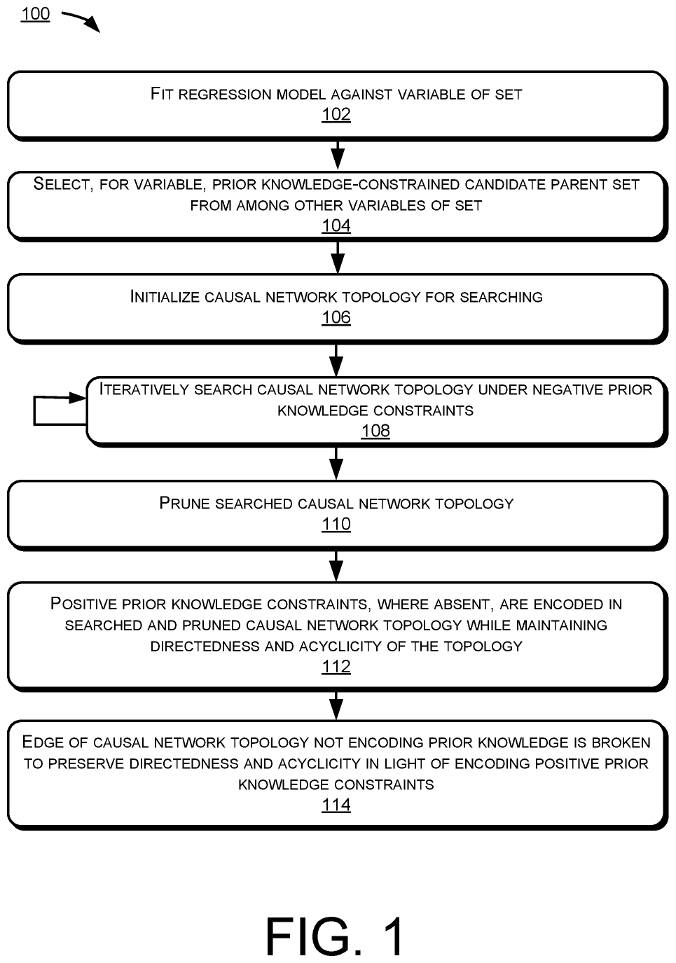

FIG. 1 illustrates a CAM regression model method 100 according to example embodiments of the present disclosure. In general, the method 100 includes steps directed to preliminary neighborhood selection, to reduce search space of a causal network search; steps directed to performing a causal network search, to optimize the causal network topology; steps directed to pruning the DAG topology; and steps directed to encoding prior knowledge.

At a step 102, a regression model is fitted against a variable of a set.

As described above, a variable set may be denoted as x₁, x₂, . . . , xₚ. For each j=1, . . . , p, a regression model is fitted for xⱼ against {x₋ⱼ}, where {x₋ⱼ} represents the set of variables other than xⱼ. The regression may be performed by gradient boosting.

Gradient boosting may iteratively fit estimated functions \hat{ƒ}(x) to approximate ƒ(x), as described above, to optimize a loss function. After some number of iterations, an estimated function may be fitted for each variable xⱼ against one or more other variables of the set.

At a step 104, for the variable, a prior knowledge-constrained candidate parent set is selected from among the other variables of the set.

According to CAM, the ten variables selected most often during 100 iterations of gradient boosting may be selected as a candidate parent set [symbol] . By reducing possible parents of a variable in scope in this manner, the scope of a subsequent causal network search may be reduced.

Additionally, according to example embodiments of the present disclosure, a further constraint may be imposed upon the candidate parent set selection: for any xₖ where prior knowledge indicates that k [symbol] j or k [symbol] j, xₖ is excluded from [symbol] (denoted as k∉ [symbol] ). Consequently, for each variable, parents which are illogical according to prior knowledge are excluded from the candidate parent set, further reducing the scope of a subsequent causal network search, decreasing workload and improving computational efficiency.

At a step 106, a causal network topology is initialized for searching.

An adjacency matrix A and a path matrix R may be initialized to encode the causal network graph topology to be searched. The coefficients of the adjacency matrix A represent inferred direct causal relationships between the variables of the set {x₁, x₂, . . . , xₚ} (i.e., a non-zero coefficient Aᵢⱼ represents an inferred causal relationship between variables xᵢ and xⱼ, and a coefficient Aᵢⱼ which is zero represents an inferred absence of a causal relationship between variables xᵢ and xⱼ). In such a causal network, vertices of a graph may represent the variables, a (directional) edge between two vertices may represent an inferred causal relationship between the variables represented by the two vertices (in the direction of the edge), and the absence of an edge between two vertices may represent an inferred absence of a causal relationship between the variables represented by the two vertices (in either direction).

The coefficients of the path matrix R represent inferred causal relationships which may or may not be direct between the variables of the set {x₁, x₂, . . . , xₚ} (i.e., a non-zero coefficient Rᵢⱼ represents an inferred path between variables xᵢ and xⱼ, and a coefficient Rᵢⱼ which is zero represents an inferred absence of any path between variables xᵢ and xⱼ). In such a causal network, a path between two vertices may include any number of (directional) edges between a starting vertex and an ending vertex, each edge representing an inferred causal relationship between two variables represented by two vertices along the path, where any number of causal relationships may connect the path from the starting vertex and the ending vertex. The absence of a path between two vertices may represent that there is no path of edges that can lead from the starting vertex to the ending vertex, though the starting vertex and the ending vertex may each be included in any number of causal relationships which do not form such a path.

At a step 108, the causal network topology is iteratively searched under prior knowledge constraints.

The causal network topology may be iteratively searched, updating a score matrix S and a design matrix D at each iteration, in order to find a causal network topology which optimizes a loss function. Unlike the adjacency matrix A and the path matrix R, a score matrix S and a design matrix D may each be updated per iteration of the causal network search to control progression of the search, as described subsequently.

A loss function encoded by a scoring matrix is described subsequently. Given N observed samples whose feature space is denoted as X∈ [symbol] ^{N×p}, accordingly X_{n,j} represents the j-th variable of the n-th instance, and Xⱼ represents the vector of j-th variable of all N samples. The expected log-likelihood under a network structure π as described above may be written as follows:

$$\begin{matrix}𝔼 [ log {P}_{π} ( X ) ] = {\sum }_{j = 1}^{P} \frac{1}{N} {\sum }_{n = 1}^{N} log P ( {X}_{n , j} \vert \{ {X}_{n , k} \vert k ∈ {pa}_{π} ( j ) \} ) \\ = {\sum }_{j = 1}^{P} \frac{1}{N} {\sum }_{n = 1}^{N} log P ( {X}_{n , j} - {\sum }_{k ∈ {pa}_{π} ( j )} {\hat{f}}_{j , k}^{π} ( {X}_{n , k} ) )\end{matrix}$$

Moreover, assuming Gaussian noise, the following further applies:

$$𝔼 [ log {P}_{π} ( X ) ] = - log ( σ ( {X}_{, j} - {\sum }_{k ∈ {pa}_{π} ( j )} {\hat{f}}_{j , k}^{π} ( {X}_{n , k} ) ) )$$

An estimation of π which optimizes the above expected log-likelihood may be written as follows:

$$\hat{π} ∈ arg {max}_{π} 𝔼 [ log {P}_{π} ( X ) ]$$

In a first iteration of a topology search, with t=1, the score matrix S^{(t)} may be populated as follows:

Sⱼ^{(t)}←−log(σ(Xⱼ))

The design matrix D^{(t)} may be populated based on the above prior knowledge constraints. Where k∉ [symbol] :

D_{k,j}^{(t)}=−inf

This encodes the exclusion of xₖ as a candidate parent for a variable xⱼ. In contrast, where k∈ [symbol] :

D_{k,j}^{(t)}←[−log(σ(Xⱼ−ƒ_{j,k}(Xₖ)))]−S_{k,j}^{(t)}

This encodes a candidate parent relationship from xₖ to the variable xⱼ. Therefore, max(D_{k,j}^{(t)})>−inf only if any xₖ is encoded as a candidate parent to the variable xⱼ.

Among these encoded candidate parents, some candidate parent relationships may further violate other encoded prior knowledge. Any such invalid candidate parents k should be similarly excluded by k∉ [symbol] . Such invalid candidate parents may be found by attempting the following assignment:

$$( k , j ) ← arg {max}_{k , j} {D}_{k , j}^{( t )}$$

Then, each negative a priori direct relationship, preceding relationship, and succeeding relationship may be checked to determine whether it is violated by this assignment. These are referred to as “negative” relationships, as they preclude the existence of relationships and paths that would otherwise be valid. In the case of any such violations, then once again D_{k,j}^{(t)}=−inf.

Subsequently, either D_{k,j}^{(t)}=−inf for all (k, j), indicating no direct relationships were found in this iteration, or otherwise max(D_{k,j}^{(t)})>−inf, indicating some direct relationship (k, j) was found this iteration. In the case that D_{k,j}^{(t)}=−inf for all (k,j), either by the search or by validity checks based on prior knowledge, t is updated to increment the search iteration and D_{k,j}^{(t)}=−inf to avoid revising the previously searched relationships.

For each direct relationship (k, j) found, Aₖⱼ is set to 1, and D_{j,k}^{(t)}=−inf is also set to prevent the topology search from creating a cycle from j back to k. Additionally, for all paths which have been formed between two different variables m and n (where, m may or may not be either of k or j, and n may or may not be either of k or j) Rₘₙ is set to 1. D_{m,n}^{(t)}=−inf is also set to prevent the topology search from revisiting the path.

A new score matrix and a new design matrix are initialized for the current iteration after incrementing iteration t. For each direct relationship found in the previous iteration t−1 (i.e., D_{k,j}^{(t-1)}≠−inf), the new score matrix S^{(t)} for the current iteration t may be initialized as follows:

S_{k,j}^{(t)}←D_{k,j}^{(t-1)}+S_{k,j}^{(t-1)},∀k

And the design matrix D^{(t)} for the current iteration t may be initialized as follows:

$${D}_{k , j}^{( t )} ← [ - log ( σ ( {X}_{, j} - {\sum }_{l ∈ {pa}_{π} ( j )} {f}_{j , l} ( {X}_{, l} ) - {f}_{j , k} ( {X}_{, k} ) ) ) ] - {S}_{k , j}^{( t )}$$

Thus, the new score matrix S^{(t)} and the new design matrix D^{(t)} may be initialized to update the loss function, influencing progression of the topology search at the current iteration t.

The iterative search repeats as described above until all relationships among the variable set (which are not invalidated by prior knowledge) are exhausted. As described above, in accordance with topological constraints of a DAG, the resulting causal network topology should have only directed edges, no undirected edges; and should have no cyclical paths which start from a particular vertex and end at the same vertex.

At a step 110, the searched causal network topology is pruned.

At the present stage, the causal network topology may include more than one path between a starting vertex and an ending vertex. The presence of more than one such path is redundant, and pruning may remove all edges making up all but one path from the same starting vertex to the same ending vertex.

Pruning may be performed according to causal additive modeling by, for example, the general additive modeling function as implemented by the mgcv software package of the R programming language. A regression model may be fitted against each variable xⱼ based on all parents of xⱼ in the searched causal network topology. Pruning may be performed based on significance testing of covariates, where significance is based on p-values less than or equal to 0.001, as known to persons skilled in the art.

At a step 112, positive prior knowledge constraints, where absent, are encoded in the searched and pruned causal network topology while maintaining directedness and acyclicity of the topology.

As each a [symbol] b direct relationship and a [symbol] b or a [symbol] b preceding and succeeding relationship has been encoded in the searched and pruned causal network topology by the above-described steps, the remaining direct relationships in the prior knowledge as denoted by a→b and a↔b should still be checked against the causal network topology. These remaining direct relationships may be referred to as “positive” relationships here, as they require the existence of relationships that may otherwise not be established in the causal network topology.

The prior knowledge encodings may be checked against the adjacency matrix A, which encodes all direct relationships of the causal network topology; they do not need to be checked against the path matrix R, as these positive relationships only require the existence of specific direct relationships, not paths.

Thus, for each k→j directed relationship encoded in the prior knowledge, as long as Aₖⱼ is set to 1, the prior knowledge is satisfied. For each k↔j undirected relationship encoded in the prior knowledge, as long as either Aₖⱼ or Aⱼₖ is set to 1, the prior knowledge is satisfied.

For each k→j directed relationship encoded in the prior knowledge, but not encoded in A, Aₖⱼ may be set to 1 to satisfy the prior knowledge, as long as Aₖⱼ does not break directedness and acyclicity constraints of DAG topology. For each k↔j directed relationship encoded in the prior knowledge, but not encoded in A, either Aₖⱼ or Aⱼₖ may be set to 1 to satisfy the prior knowledge, as long as either Aₖⱼ or Aⱼₖ does not break directedness and acyclicity constraints of DAG topology.

In the event that, in the first case, Aₖⱼ breaks directedness or acyclicity constraints, or, in the second case, both Aₖⱼ and Aⱼₖ break directedness and acyclicity constraints, another edge of the causal network topology must be broken in order to satisfy the prior knowledge; thus, adherence to prior knowledge is prioritized over optimizing the loss function, but is not prioritized over directedness and acyclicity.

At a step 114, an edge of the causal network topology not encoding prior knowledge is broken to preserve directedness and acyclicity in light of encoding the positive prior knowledge constraints.

This step may be performed similar to pruning above according to, for example, the general additive modeling function as implemented by the mgcv software package of the R programming language. Once again, a regression model may be fitted against each variable xⱼ based on all parents of xⱼ in the searched causal network topology. Breaking of an edge may be performed based on significance testing of covariates, where significance is based on p-values.

Upon deriving p-values of each parent of xⱼ, any edge which does not encode a positive direct relationship as described above may be a candidate for breaking. Among these candidate edges, a candidate with a largest p-value may be broken. This preserves directedness and acyclicity, in light of encoding the positive prior knowledge constraints.

Example embodiments of the present disclosure may be implemented on server hosts and computing hosts. Server hosts may be any suitable networked server, such as cloud computing systems, which may provide collections of servers hosting computing resources such as a database containing multivariate time series data or multiple univariate time series data. Computing hosts such as data centers may host regression models according to example embodiments of the present disclosure to provide functions in accordance to optimize a causal additive modeling regression model subject to prior knowledge constraints.

A cloud computing system may connect to various end devices which users may operate to collect data, organize data, set parameters, and run the regression model to perform optimization. End devices may connect to the server hosts through one or more networks, such as edge nodes of the cloud computing system. An edge node may be any server providing an outbound connection from connections to other nodes of the cloud computing system, and thus may demarcate a logical edge, and not necessarily a physical edge, of a network of the cloud computing system. Moreover, an edge node may be edge-based logical nodes that deploy non-centralized computing resources of the cloud computing system, such as cloudlets, fog nodes, and the like.

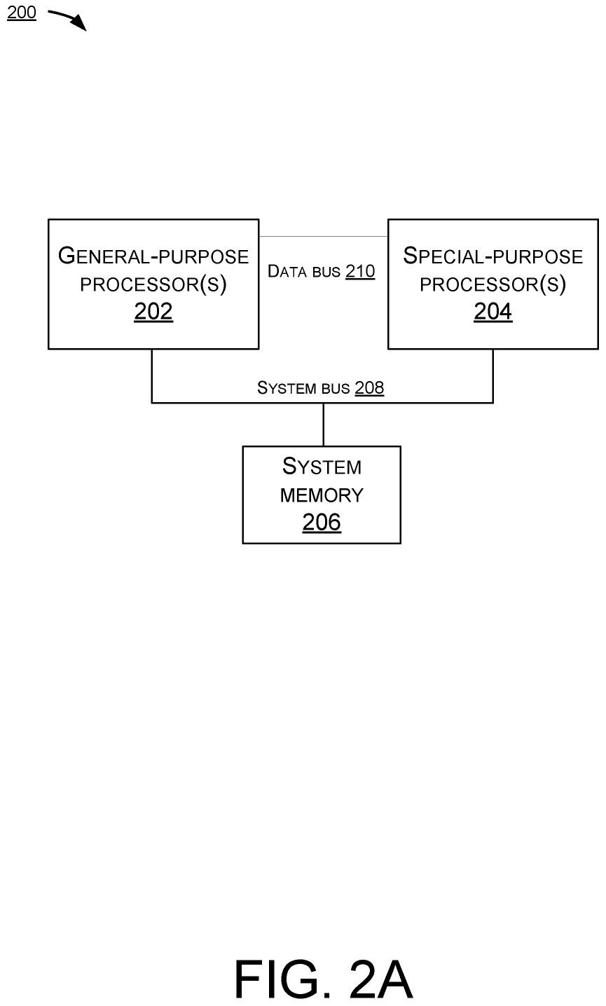

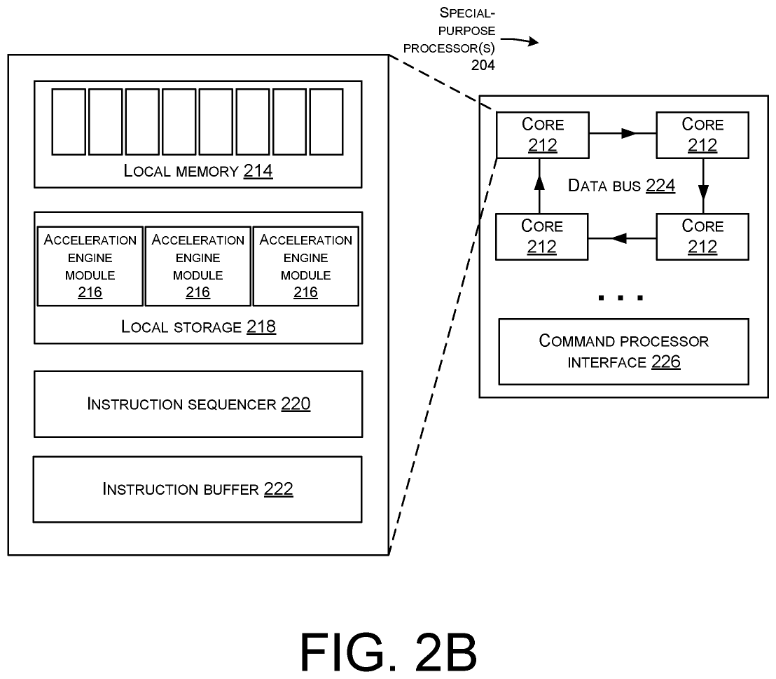

FIGS. 2A and 2B illustrate a system architecture of a system 200 configured to compute causal additive modeling regression according to example embodiments of the present disclosure.

A system 200 according to example embodiments of the present disclosure may include one or more general-purpose processor(s) 202 and one or more special-purpose processor(s) 204. The general-purpose processor(s) 202 and special-purpose processor(s) 204 may be physical or may be virtualized and/or distributed. The general-purpose processor(s) 202 and special-purpose processor(s) 204 may execute one or more instructions stored on a computer-readable storage medium as described below to cause the general-purpose processor(s) 202 or special-purpose processor(s) 204 to perform a variety of functions. Special-purpose processor(s) 204 may be computing devices having hardware or software elements facilitating computation of neural network computing tasks such as training and inference computations. For example, special-purpose processor(s) 204 may be accelerator(s), such as Neural Network Processing Units (“NPUs”), Graphics Processing Units (“GPUs”), Tensor Processing Units (“TPU”), implementations using field programmable gate arrays (“FPGAs”) and application specific integrated circuits (“ASICs”), and/or the like. To facilitate computation of tasks such as training and inference, special-purpose processor(s) 204 may, for example, implement engines operative to compute mathematical operations such as matrix operations and vector operations.

A system 200 may further include a system memory 206 communicatively coupled to the general-purpose processor(s) 202 and the special-purpose processor(s) 204 by a system bus 208. The system memory 206 may be physical or may be virtualized and/or distributed. Depending on the exact configuration and type of the system 200, the system memory 206 may be volatile, such as RAM, non-volatile, such as ROM, flash memory, miniature hard drive, memory card, and the like, or some combination thereof.

The system bus 208 may transport data between the general-purpose processor(s) 202 and the system memory 206, between the special-purpose processor(s) 204 and the system memory 206, and between the general-purpose processor(s) 202 and the special-purpose processor(s) 204. Furthermore, a data bus 210 may transport data between the general-purpose processor(s) 202 and the special-purpose processor(s) 204. The data bus 210 may, for example, be a Peripheral Component Interconnect Express (“PCIe”) connection, a Coherent Accelerator Processor Interface (“CAPI”) connection, and the like.

FIG. 2B illustrates an example of special-purpose processor(s) 204, including any number of core(s) 212. Processing power of the special-purpose processor(s) 204 may be distributed among the core(s) 212. Each core 212 may include local memory 214, which may contain pre-initialized data, such as kernel functions, or data structures, such as matrices as described above, for the performance of special-purpose computing. Each core 212 may further be configured to execute one or more sets of computer-executable acceleration engine modules 216 pre-initialized on local storage 218 of the core 212, which may each be executable by the core(s) 212, including execution in parallel by multiple core(s) 212, to perform or accelerate, for example, arithmetic operations such as matrix multiplication or matrix transformation, gradient boosting, or specially defined operations such as searching a causal network topology as defined herein. Each core 212 may further include an instruction sequencer 220, which receives and orders instructions received from an instruction buffer 222. Some number of core(s) 212, such as four, may be in communication by a data bus 224, such as a unidirectional ring bus. Software drivers controlling operation of each core 212 may control the core(s) 212 and synchronize their operations by sending executable commands through a command processor interface 226.

Multivariate data series or multiple univariate data series may be transported to special-purpose processor(s) 204 over a system bus 208 or a data bus 210, where causal additive model regression may be performed by the special-purpose processor(s) 204 on the variable sets as described herein, and output adjacency matrices and path matrices as described herein.

Causal inference networks output by models according to example embodiments of the present disclosure may be applied to practical problems such as root cause analysis (“RCA”); causal impact analysis; Bayesian inference, which may be utilized to create probability models; and the like.

By way of illustration, example embodiments of the present disclosure may be applied to retail of goods to customers in varied geographical regions. Domain knowledge pertaining to retail of goods may include, for example, the knowledge that low inventory levels for certain goods increases demand for those goods. For example, customers who observe toiletries selling out may wish to buy those toiletries in larger numbers once they are restocked. Such domain knowledge may be encoded as a positive prior knowledge constraint, where inventory levels of a product A falling below a particular level leads either directly or ultimately to demand levels of the product A rising above a particular level. Such a structural constraint encoded in a causal inference network may enable vendors of goods to determine when inventory levels should be increased.

By way of illustration, example embodiments of the present disclosure may be applied to monitoring of customer engagement with a business's web presence. Domain knowledge pertaining to customer engagement may include, for example, the knowledge that updates to a business's web presence which do not reflect recent real-life events do not increase customer engagement. For example, customers may lose interest in a company's social media pages when they omit references to noteworthy news events. Such domain knowledge may be encoded as a negative prior knowledge constraint, where web presence updates of a certain type do not lead directly or ultimately to increased customer engagement. Such a structural constraint encoded in a causal reference network may enable businesses to determine how frequently to post updates reflecting real-life events.

By way of illustration, example embodiments of the present disclosure may be applied to diagnosis of events of unknown origin in an IT system. Domain knowledge pertaining to diagnosis of events may include, for example, the knowledge that an error in an IT system occurs at the start of a month but not at the end of a month. Such domain knowledge may be encoded as a positive prior knowledge constraint, where the first half of any month leads directly or ultimately to occurrence of the error, and as a negative prior knowledge constraint, where the second half of any month does not lead directly or ultimately to occurrence of the error. Such a structural constraint encoded in a causal reference network may enable system administrators to identify causes of the error which may more clearly indicate causation rather than mere correlation.

Furthermore, by way of illustration, example embodiments of the present disclosure may be applied to anomaly detection in business operations. It is desired to detect outlier data amongst values of variables observed during the routine conduct of business operations, as such outliers may indicate rapid increases or decreases of customer complaints, rapid increases or decreases of GMV, and other such phenomena that require remediation, intervention, and the like.

Additionally, it is desired to determine a causal basis for the observed outlier data. For example, such rapid increases of customer complaints may be caused by bottlenecks or failures in commodity distribution chains or inventory shortages; such rapid increases of GMV and rapid decreases of customer complaints may be caused by so-called “brushing” scams. However, various established techniques within the discipline of anomaly detection fail to uncover the causal basis or root cause of observed anomalies.

Additionally, causal basis of an anomalous value of an observed variable at a certain time along a time series may be confounded by the occurrence of other variables at the same time, especially if any other variable also exhibits anomalous values at, or close to, the same time.

Therefore, according to example embodiments of the present disclosure, a prior knowledge-enhanced causal additive model as described herein is applied to multiple observed variables, independent of the collection of any time series data, resulting in a causal network topology.

Based on the causal network topology, given an anomalous value of an observed variable, each other variable having a causal relationship leading to that observed variable (subsequently referred to as each “cause” of the observed variable) may be identified. For each cause, a magnitude of a causal effect of that cause upon the observed variable may be measured separately. The magnitude of the causal effect of each cause may be measured by holding initial parameterization of each other variable constant, and varying initial parameterization of the cause. Subsequently, one or more causes having largest magnitudes of causal effect upon the abnormal observed variable may be regarded as one or more causes of the observed abnormality, and this information may be acted upon for the purpose of remediation, intervention, and the like, including on a real-time basis.

For example, measuring a magnitude of a causal effect of a cause upon the observed variable may be conducted by an A/B testing framework stored on a computer-readable storage medium and configured to cause general-purpose processor(s) and/or special-purpose processor(s) to parameterize and execute some number of A/B tests in memory. According to example embodiments of the present disclosure, an A/B test parameterized and executed by general-purpose processor(s) and/or special-purpose processor(s) based on an A/B testing framework may include multiple sets of computer-executable instructions, each corresponding to a variant of the A/B test, wherein for each variant of the A/B test, initial parameterization of the cause as described above is parameterized differently and initial parameterization of each other variable is constant. Each A/B test in memory may then be executed by the general-purpose processor(s) and/or special-purpose processor(s) based on the A/B testing framework to derive a result of each A/B test variant, each result including at least an observed value of the observed variable, and these results may each be compared to determine which cause has a largest magnitude of causal effect upon the observed variable.

To achieve the above, an interface of the A/B testing framework may receive the set of causes of the observed variable, as described above, as inputs. For each cause among the set of causes, general-purpose processor(s) and/or special-purpose processor(s) may generate a different A/B test based on the A/B framework, where each A/B test has multiple variants, each variant having a different initial parameterization of the cause.

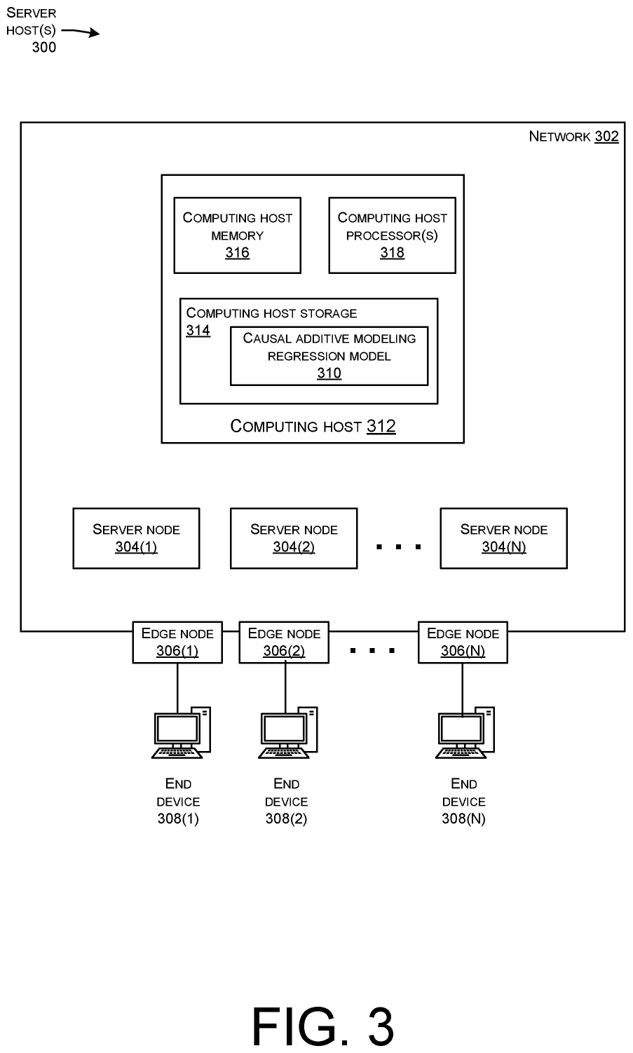

FIG. 3 illustrates an architectural diagram of server host(s) 300 and a computing host for computing resources and causal additive modeling regression model according to example embodiments of the present disclosure. As described above, according to example embodiments of the present disclosure, a cloud computing system may be operative to provide server host functionality for hosting computing resources, supported by a computing host such as a data center hosting a causal additive modeling regression model. Thus, this figure illustrates some possible architectural embodiments of computing devices as described above.

The server host(s) 300 may be implemented over a network 302 of physical or virtual server nodes 304(1), 304(2), . . . , 304(N) (where any unspecified server node may be referred to as a server node 304) connected by physical or virtual network connections. Furthermore, the network 302 terminates at physical or virtual edge nodes 306(1), 306(2), . . . , 306(N) (where any unspecified edge node may be referred to as an edge node 306) located at physical and/or logical edges of the network 302. The edge nodes 306(1) to 306(N) may connect to any number of end devices 308(1), 308(2), . . . , 308(N) (where any unspecified end device may be referred to as an end device 308).

A causal additive modeling regression model 310 implemented on a computing host accessed through an interface of the server host(s) 300 as described in example embodiments of the present disclosure may be stored on physical or virtual storage of a computing host 312 (“computing host storage 314”), and may be loaded into physical or virtual memory of the computing host 312 (“computing host memory 316”) in order for one or more physical or virtual processor(s) of the computing host 312 (“computing host processor(s) 318”) to perform computations using the causal additive modeling regression model 310 to compute time series data related to optimization as described herein. Computing host processor(s) 318 may be special-purpose computing devices facilitating computation of matrix arithmetic computing tasks. For example, computing host processor(s) 318 may be one or more special-purpose processor(s) 304 as described above, including accelerator(s) such as NPUs, GPUs, TPUs, and the like.

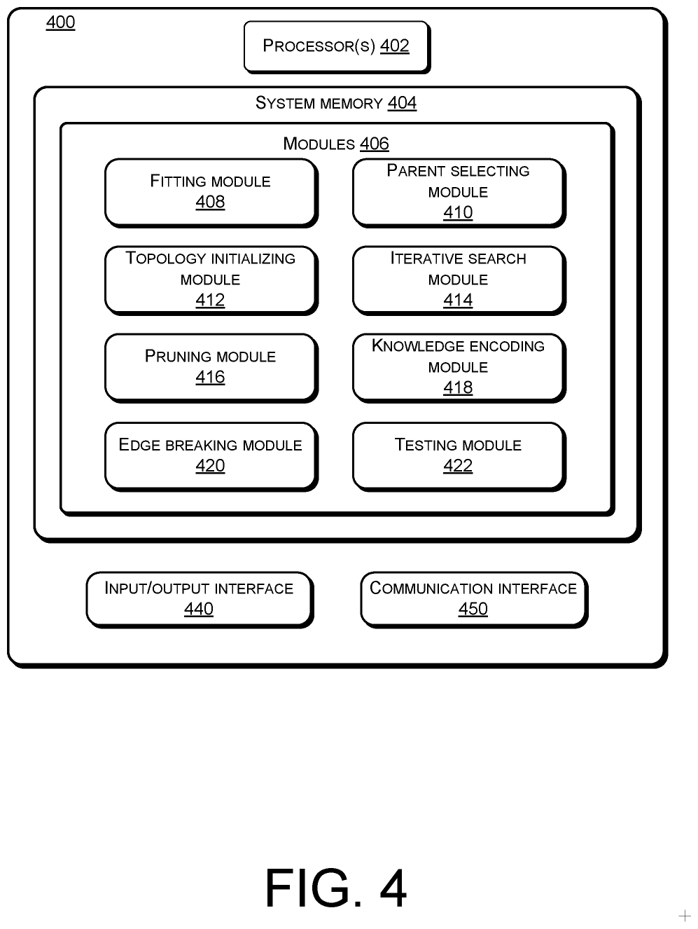

According to example embodiments of the present disclosure, different modules of a causal additive modeling regression model as described below with reference to FIG. 4 may be executed by different processors of the computing host processor(s) 318 or may execute by a same processor of the computing host processor(s) 318 on different cores or different threads, and each module may perform computation concurrently relative to each other submodule.

FIG. 4 illustrates an example computing system 400 for implementing the processes and methods described above for implementing a causal additive modeling regression model.

The techniques and mechanisms described herein may be implemented by multiple instances of the computing system 400, as well as by any other computing device, system, and/or environment. The computing system 400, as described above, may be any varieties of computing devices, such as personal computers, personal tablets, mobile devices, other such computing devices operative to perform matrix arithmetic computations. The system 400 shown in FIG. 4 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 400 may include one or more processors 402 and system memory 404 communicatively coupled to the processor(s) 402. The processor(s) 402 and system memory 404 may be physical or may be virtualized and/or distributed. The processor(s) 402 may execute one or more modules and/or processes to cause the processor(s) 402 to perform a variety of functions. In embodiments, the processor(s) 402 may include a central processing unit (“CPU”), a GPU, an NPU, a TPU, any combinations thereof, or other processing units or components known in the art. Additionally, each of the processor(s) 402 may possess its own local memory, which also may store program modules, program data, and/or one or more operating systems.

Depending on the exact configuration and type of the system 400, the system memory 404 may be volatile, such as RAM, non-volatile, such as ROM, flash memory, miniature hard drive, memory card, and the like, or some combination thereof. The system memory 404 may include one or more computer-executable modules 406 that are executable by the processor(s) 402. The modules 406 may be hosted on a network as services for a data processing platform, which may be implemented on a separate system from the system 400.

The modules 406 may include, but are not limited to, a fitting module 408, a parent selecting module 410, a topology initializing module 412, an iterative search module 414, a pruning module 416, a knowledge encoding module 418, and an edge breaking module 420, and a testing module 422.

The fitting module 408 may be executed by the processor(s) 402 to fit a regression model against a variable as described above with reference to several steps of FIG. 1, including step 102, step 110, and step 114.

The parent selecting module 410 may be executed by the processor(s) 402 to select a prior knowledge-constrained candidate parent set as described above with reference to step 104.

The topology initializing module 412 may be executed by the processor(s) 402 to initialize a causal network topology as described above with reference to step 106.

The iterative search module 414 may be executed by the processor(s) 402 to iteratively search a causal network topology under negative prior knowledge constraints as described above with reference to step 108.

The pruning module 416 may be executed by the processor(s) 402 to prune a searched causal network topology as described above with reference to step 110.

The knowledge encoding module 418 may be executed by the processor(s) 402 to determine positive prior knowledge constraints absent from a searched and pruned causal network topology and encode positive prior knowledge constraints as described above with reference to step 112.

The edge breaking module 420 may be executed by the processor(s) 402 to break an edge of a causal network topology not encoding prior knowledge as described above with reference to step 114.

The testing module 422 maybe executed by the processor(s) 402 to generate, parameterize, and execute some number of A/B tests in memory as described above.

The system 400 may additionally include an input/output (“I/O”) interface 440 and a communication module 450 allowing the system 400 to communicate with other systems and devices over a network, such as server host(s) as described above. The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media that, when executed by one or more processors, may perform operations described above with reference to FIGS. 1-3. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

By the abovementioned technical solutions, example embodiments of the present disclosure provide optimizing a causal additive model conforming to structural constraints of directedness and acyclicity, and also encoding both positive and negative relationship constraints reflected by prior knowledge, so that the model, during fitting to one or more sets of observed variables, will tend to match expected observations as well as domain-specific reasoning regarding causality, and will conform to directedness and acyclicity requirements for Bayesian statistical distributions. Computational workload is decreased and computational efficiency is increased due to the implementation of causal additive model improvements to reduce search space and enforce directedness, while intuitive correctness of the outcome causality is ensured by prioritizing encoding of prior knowledge over optimizing a loss function.

### EXAMPLE CLAUSES

A. A method comprising: determining, by one or more processors of a computing system, a prior knowledge constraint absent from a searched causal network topology in memory of the computing system; and encoding, by the one or more processors, the prior knowledge constraint in the searched causal network topology while maintaining directedness and acyclicity of the searched causal network topology.

B. The method as paragraph A recites, wherein encoding, by the one or more processors, the prior knowledge constraint comprises encoding, by the one or more processors, an edge of the searched causal network topology in an adjacency matrix.

C. The method as paragraph B recites, wherein the encoded edge is based on a directed or undirected positive relationship of the prior knowledge constraint.

D. The method as paragraph C recites, further comprising breaking, by the one or more processors, an edge of the searched causal network topology not encoding a prior knowledge constraint.

E. The method as paragraph A recites, wherein the searched causal network topology is derived by iteratively searching, by the one or more processors, an initialized causal network topology in the memory of the computing system based on negative prior knowledge constraints.

F. The method as paragraph E recites, wherein iteratively searching the initialized causal network topology comprises iteratively updating, by the one or more processors, a design matrix to remove a relationship invalidated by a negative prior knowledge constraint, the negative prior knowledge constraint comprising one of a directed relationship constraint, a preceding relationship constraint, and a succeeding relationship constraint.

G. The method as paragraph E recites, wherein the initialized causal network topology is initialized by the one or more processors based on a prior knowledge-constrained candidate parent set.

H. The method as paragraph A recites, further comprising outputting, by the one or more processors, a set of causes of an observed variable having an anomalous value to an interface of an A/B testing framework; and generating, by the one or more processors based on the A/B testing framework, an A/B test in the memory of the computing system for each cause among the set of causes, each A/B test having a plurality of variants, and each variant having a different initial parameterization of the cause.

I. A system comprising: one or more processors; and memory communicatively coupled to the one or more processors, the memory storing computer-executable modules executable by the one or more processors that, when executed by the one or more processors, perform associated operations, the computer-executable modules comprising: a knowledge encoding module executable by the one or more processors to determine a prior knowledge constraint absent from a searched causal network topology in the memory; and to encode the prior knowledge constraint in the searched causal network topology while maintaining directedness and acyclicity of the searched causal network topology.

J. The system as paragraph I recites, wherein the knowledge encoding module is executable by the one or more processors to encode the prior knowledge constraint by encoding an edge of the searched causal network topology in an adjacency matrix.

K. The system as paragraph J recites, wherein the encoded edge is based on a directed or undirected positive relationship of the prior knowledge constraint.

L. The system as paragraph K recites, wherein the computer-executable modules further comprise an edge breaking module executable by the one or more processors to break an edge of the searched causal network topology not encoding a prior knowledge constraint.

M. The system as paragraph I recites, wherein the computer-executable modules further comprise an iterative search module executable by the one or more processors to iteratively search an initialized causal network topology in the memory based on negative prior knowledge constraints, deriving the searched causal network topology.

N. The system as paragraph M recites, wherein the iterative search module is executable by the one or more processors to iteratively search the initialized causal network topology by iteratively updating a design matrix to remove a relationship invalidated by a negative prior knowledge constraint, the negative prior knowledge constraint comprising one of a directed relationship constraint, a preceding relationship constraint, and a succeeding relationship constraint.

O. The system as paragraph M recites, wherein the computer-executable modules further comprise a topology initializing module executable by the one or more processors to initialize the searched causal network topology based on a prior knowledge-constrained candidate parent set.

P. The system as paragraph I recites, wherein the computer-executable modules further comprise a testing module executable by the one or more processors to receive, as input, a set of causes of an observed variable having an anomalous value, and to generate an A/B test in the memory for each cause among the set of causes, each A/B test having a plurality of variants, and each variant having a different initial parameterization of the cause.

Q. A computer-readable storage medium storing computer-readable instructions executable by one or more processors, that when executed by the one or more processors, cause the one or more processors to perform operations comprising: determining a prior knowledge constraint absent from a searched causal network topology in memory of the computing system; and encoding the prior knowledge constraint in the searched causal network topology while maintaining directedness and acyclicity of the searched causal network topology.

R. The computer-readable storage medium as paragraph Q recites, wherein encoding the prior knowledge constraint comprises encoding an edge of the searched causal network topology in an adjacency matrix.

S. The computer-readable storage medium as paragraph R recites, wherein the encoded edge is based on a directed or undirected positive relationship of the prior knowledge constraint.

T. The computer-readable storage medium as paragraph S recites, wherein the operations further comprise breaking an edge of the searched causal network topology not encoding a prior knowledge constraint.

U. The computer-readable storage medium as paragraph Q recites, wherein the searched causal network topology is derived by iteratively searching an initialized causal network topology in the memory of the computing system based on negative prior knowledge constraints.

V. The computer-readable storage medium as paragraph U recites, wherein causing the one or more processors to iteratively search the initialized causal network topology comprises causing the one or more processors to iteratively update a design matrix to remove a relationship invalidated by a negative prior knowledge constraint, the negative prior knowledge constraint comprising one of a directed relationship constraint, a preceding relationship constraint, and a succeeding relationship constraint.

W. The computer-readable storage medium as paragraph U recites, wherein the initialized causal network topology is initialized by the one or more processors based on a prior knowledge-constrained candidate parent set.

X. The computer-readable storage medium as paragraph Q recites, wherein the operations further comprise a set of causes of an observed variable having an anomalous value to an interface of an A/B testing framework; and generating, based on the A/B testing framework, an A/B test in the memory of the computing system for each cause among the set of causes, each A/B test having a plurality of variants, and each variant having a different initial parameterization of the cause.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
determining, by one or more processors of a computing system, a prior knowledge constraint absent from a searched causal network topology in memory of the computing system; and
encoding, by the one or more processors, the prior knowledge constraint in the searched causal network topology while maintaining directedness and acyclicity of the searched causal network topology.

2. The method of claim 1, wherein encoding, by the one or more processors, the prior knowledge constraint comprises encoding, by the one or more processors, an edge of the searched causal network topology in an adjacency matrix.

3. The method of claim 2, wherein the encoded edge is based on a directed or undirected positive relationship of the prior knowledge constraint.

4. The method of claim 3, further comprising breaking, by the one or more processors, an edge of the searched causal network topology not encoding a prior knowledge constraint.

5. The method of claim 1, wherein the searched causal network topology is derived by iteratively searching, by the one or more processors, an initialized causal network topology in the memory of the computing system based on negative prior knowledge constraints.

6. The method of claim 5, wherein iteratively searching the initialized causal network topology comprises iteratively updating, by the one or more processors, a design matrix to remove a relationship invalidated by a negative prior knowledge constraint, the negative prior knowledge constraint comprising one of a directed relationship constraint, a preceding relationship constraint, and a succeeding relationship constraint.

7. The method of claim 5, wherein the initialized causal network topology is initialized by the one or more processors based on a prior knowledge-constrained candidate parent set.

8. A system comprising:
one or more processors; and
memory communicatively coupled to the one or more processors, the memory storing computer-executable modules executable by the one or more processors that, when executed by the one or more processors, perform associated operations, the computer-executable modules comprising:
a knowledge encoding module executable by the one or more processors to determine a prior knowledge constraint absent from a searched causal network topology in the memory; and to encode the prior knowledge constraint in the searched causal network topology while maintaining directedness and acyclicity of the searched causal network topology.

9. The system of claim 8, wherein the knowledge encoding module is executable by the one or more processors to encode the prior knowledge constraint by encoding an edge of the searched causal network topology in an adjacency matrix.

10. The system of claim 9, wherein the encoded edge is based on a directed or undirected positive relationship of the prior knowledge constraint.

11. The system of claim 10, wherein the computer-executable modules further comprise an edge breaking module executable by the one or more processors to break an edge of the searched causal network topology not encoding a prior knowledge constraint.

12. The system of claim 8, wherein the computer-executable modules further comprise an iterative search module executable by the one or more processors to iteratively search an initialized causal network topology in the memory based on negative prior knowledge constraints, deriving the searched causal network topology.

13. The system of claim 12, wherein the iterative search module is executable by the one or more processors to iteratively search the initialized causal network topology by iteratively updating a design matrix to remove a relationship invalidated by a negative prior knowledge constraint, the negative prior knowledge constraint comprising one of a directed relationship constraint, a preceding relationship constraint, and a succeeding relationship constraint.

14. The system of claim 14, wherein the computer-executable modules further comprise a topology initializing module executable by the one or more processors to initialize the searched causal network topology based on a prior knowledge-constrained candidate parent set.

15. A computer-readable storage medium storing computer-readable instructions executable by one or more processors, that when executed by the one or more processors, cause the one or more processors to perform operations comprising:
determining a prior knowledge constraint absent from a searched causal network topology in memory of the computing system; and
encoding the prior knowledge constraint in the searched causal network topology while maintaining directedness and acyclicity of the searched causal network topology.

16. The computer-readable storage medium of claim 15, wherein encoding the prior knowledge constraint comprises encoding, by the one or more processors, an edge of the searched causal network topology in an adjacency matrix.

17. The computer-readable storage medium of claim 16, wherein the encoded edge is based on a directed or undirected positive relationship of the prior knowledge constraint.

18. The computer-readable storage medium of claim 15, wherein the causal network topology is derived by causing the one or more processors to iteratively search an initialized causal network topology in the memory of the computing system based on negative prior knowledge constraints.

19. The computer-readable storage medium of claim 18, wherein causing the one or more processors to iteratively search the initialized causal network topology comprises causing the one or more processors to iteratively update a design matrix to remove a relationship invalidated by a negative prior knowledge constraint, the negative prior knowledge constraint comprising one of a directed relationship constraint, a preceding relationship constraint, and a succeeding relationship constraint.

20. The computer-readable storage medium of claim 18, wherein the causal network topology is initialized by the one or more processors based on a prior knowledge-constrained candidate parent set.
